(19) United States
(12) Patent Application Publication
(10) Pub. No.: US 2022/0198241 A1
(43) Pub. Date: Jun. 23, 2022

(54) NONCONTACT COMMUNICATION MEDIUM

(71) Applicant: FUJIFILM CORPORATION, Tokyo (JP)

(72) Inventor: Eiichiro KATAOKA, Kanagawa (JP)

(21) Appl. No.: 17/553,810

(22) Filed: Dec. 17, 2021

(30) Foreign Application Priority Data
Dec. 22, 2020 (JP) 2020-212861

(51) Int. Cl. G06K 19/077

(52) U.S. Cl. CPC G06K 19/07781; G06K 19/07794; G06K 19/07775

(57) ABSTRACT

A noncontact communication medium comprises an antenna coil that is formed in a substrate and induces power with application of a magnetic field from an outside, and a processing circuit that operates using the power induced by the antenna coil. The substrate has a plurality of layers in a thickness direction. The antenna coil is wound in a loop shape in a first layer among the plurality of layers. One end and the other end of the antenna coil are electrically connected through an auxiliary antenna coil wound in a loop shape in a second layer different from the first layer among the plurality of layers. At least one of the first layer or the second layer is buried in the substrate.

### CROSS-REFERENCE TO RELATED APPLICATIONS

This application claims priority under 35 USC 119 from Japanese Patent Application No. 2020-212861 filed on Dec. 22, 2020, the disclosure of which is incorporated by reference herein.

### BACKGROUND

### 1. Technical Field

A technique of the present disclosure relates to a noncontact communication medium.

### 2. Related Art

JP2009-080843A discloses a semiconductor device that is mounted on a card body comprising an antenna coil for performing wireless communication with an external transmission and reception device. The semiconductor device described in JP2009-080843A has a wiring board, a first connection terminal, a second connection terminal, a semiconductor chip, a third connection terminal, a fourth connection terminal, and a capacitor. The wiring board has a main surface and a back surface on an opposite side to the main surface. The first connection terminal is provided on the main surface of the wiring board and is electrically connected to one end of the antenna coil through a first conductive material. The second connection terminal is provided on the main surface of the wiring board and is electrically connected to the other end of the antenna coil through the first conductive material. The semiconductor chip is mounted on the main surface of the wiring board, is further electrically connected to the first connection terminal and the second connection terminal, and performs data processing. The third connection terminal is provided on the main surface of the wiring board and is electrically connected to the first connection terminal by wiring of the wiring board. The fourth connection terminal is provided on the main surface of the wiring board and is electrically connected to the second connection terminal by wiring. The capacitor has one end electrically connected to the third connection terminal and the other end electrically connected to the fourth connection terminal by a second conductive material to form a resonance circuit. In the semiconductor device described in JP2009-080843A, the first connection terminal and the second connection terminal are disposed on different sides of the semiconductor chip.

JP2004-318657A discloses a contact/noncontact compound IC card in which an antenna coil for data reception and transmission is disposed inside a substrate and that has a COB incorporating an IC chip having a terminal for data reception and transmission on a substrate front surface. In the IC card described in JP2004-318657A, a metal plate having at least one or more undulated portions is disposed inside the substrate, and a terminal of the antenna coil and a connection terminal of the COB are connected to the metal plate.

JP2015-114754A discloses an IC card comprising at least an IC chip, a connection terminal substrate, and a circuit pattern. The IC chip has both a contact communication function and a noncontact communication function. The connection terminal substrate includes an external connection terminal having a plurality of compartments and an RF connection terminal. The circuit pattern includes an antenna coil and an antenna coil connection terminal. The RF connection terminal and the antenna coil connection terminal are connected through a bonding material at least containing a conductive substance. In the IC card described in JP2015-114754A, the connection terminal substrate has holes in a connection terminal base material in the compartments not used for contact communication, and the external connection terminal and an antenna connection terminal are connected by metal.

### SUMMARY

An embodiment according to the technique of the present disclosure provides a noncontact communication medium capable of increasing the durability of at least one of an antenna coil or an auxiliary antenna coil compared to a case where both of a first layer in which the antenna coil is formed and a second layer in which the auxiliary antenna coil is formed are exposed on a substrate.

A first aspect according to the technique of the present disclosure is a noncontact communication medium comprising an antenna coil that is formed in a substrate and induces power with application of a magnetic field from an outside, and a processing circuit that operates with the power induced by the antenna coil, in which the substrate has a plurality of layers in a thickness direction, the antenna coil is wound in a loop shape in a first layer among the plurality of layers, one end and the other end of the antenna coil are electrically connected through an auxiliary antenna coil wound in a loop shape in a second layer different from the first layer among the plurality of layers, and at least one of the first layer or the second layer is buried in the substrate.

A second aspect according to the technique of the present disclosure is the noncontact communication medium according to the first aspect, in which the one end and the other end are electrically connected in the second layer through a through-hole.

A third aspect according to the technique of the present disclosure is the noncontact communication medium according to the first aspect or the second aspect, in which both the first layer and the second layer are buried in the substrate.

A fourth aspect according to the technique of the present disclosure is the noncontact communication medium according to the third aspect, in which a first distance indicating a distance between a center of the substrate in the thickness direction and the first layer is equal to a second distance indicating a distance between the center of the substrate in the thickness direction and the second layer.

A fifth aspect according to the technique of the present disclosure is the noncontact communication medium according to any one of the first aspect to the fourth aspect, in which the antenna coil formed in the first layer and the auxiliary antenna coil formed in the second layer are disposed in a zigzag pattern in the thickness direction of the substrate.

A sixth aspect according to the technique of the present disclosure is the noncontact communication medium according to any one of the first aspect to the fifth aspect, in which the processing circuit is formed in an IC chip, and the IC chip is mounted on the first layer and is inserted in the middle of the antenna coil formed in the first layer.

A seventh aspect according to the technique of the present disclosure is the noncontact communication medium according to the sixth aspect, in which the first layer is buried in the substrate.

An eighth aspect according to the technique of the present disclosure is the noncontact communication medium according to the seventh aspect, in which a front surface or a back surface of the substrate has an exposure opening for exposing the IC chip mounted on the first layer.

A ninth aspect according to the technique of the present disclosure is the noncontact communication medium according to the seventh aspect, in which a front surface or a back surface of the substrate has an opening formed at a position corresponding to a position of the IC chip mounted on the first layer, and the opening is sealed with a sealing material.

A tenth aspect according to the technique of the present disclosure is the noncontact communication medium according to the ninth aspect, in which a size of the opening is determined in association with a management standard of a glob top that is applied to the noncontact communication medium.

An eleventh aspect according to the technique of the present disclosure is the noncontact communication medium according to any one of the first aspect to the fifth aspect, in which the processing circuit is formed in an IC chip, and the IC chip is mounted on a third layer different from the first layer and the second layer among the plurality of layers.

A twelfth aspect according to the technique of the present disclosure is the noncontact communication medium according to the eleventh aspect, in which the third layer is a front surface or a back surface of the substrate.

### BRIEF DESCRIPTION OF THE DRAWINGS

Exemplary embodiments of the present invention will be described in detail based on the following figures, wherein:

FIG. 1 is a schematic perspective view showing an example of the appearance of a magnetic tape cartridge according to an embodiment;

FIG. 2 is a schematic perspective view showing an example of the structure of a rear right end portion inside a lower case of the magnetic tape cartridge according to the embodiment;

FIG. 3 is a side cross-sectional view showing an example of a support member provided on an inner surface of the lower case of the magnetic tape cartridge according to the embodiment;

FIG. 4 is a schematic configuration diagram showing an example of the hardware configuration of the magnetic tape drive according to the embodiment;

FIG. 5 is a schematic perspective view showing an example of an aspect in which a magnetic field is discharged from a lower side of the magnetic tape cartridge according to the embodiment by a noncontact reading and writing device;

FIG. 6 is a conceptual diagram showing an example of an aspect in which a magnetic field is applied from the noncontact reading and writing device to a cartridge memory in the magnetic tape cartridge according to the embodiment;

FIG. 7 is an exploded view showing an example of the structure of the cartridge memory according to the embodiment;

FIG. 8 is a schematic sectional view of the cartridge memory shown in FIG. 7 taken along the line A-A;

FIG. 9 is a schematic circuit diagram showing an example of the circuit configuration of the cartridge memory according to the embodiment;

FIG. 10 is a schematic sectional view showing a modification example of the cartridge memory;

FIG. 11 is an exploded view showing a modification example of the cartridge memory;

FIG. 12 is an exploded view showing another modification example of the cartridge memory; and

FIG. 13 is a conceptual diagram showing a modification example of an inclination angle of the cartridge memory in the magnetic tape cartridge.

### DETAILED DESCRIPTION

First, terms that are used in the following description will be described.

CPU is an abbreviation for “Central Processing Unit”. RAM is an abbreviation for “Random Access Memory”. NVM is an abbreviation for “Non-Volatile Memory”. ROM is an abbreviation for “Read Only Memory”. EEPROM is an abbreviation for “Electrically Erasable and Programmable Read Only Memory”. SSD is an abbreviation for “Solid State Drive”. USB is an abbreviation for “Universal Serial Bus”. ASIC is an abbreviation for “Application Specific Integrated Circuit”. PLD is an abbreviation for “Programmable Logic Device”. FPGA is an abbreviation for “Field-Programmable Gate Array”. SoC is an abbreviation for “System-on-a-Chip”. IC is an abbreviation for “Integrated Circuit”. RFID is an abbreviation for “Radio Frequency Identifier”. LTO is an abbreviation for “Linear Tape-Open”. COB is an abbreviation for “Chip On Board”. RF is an abbreviation for “Radio Frequency”.

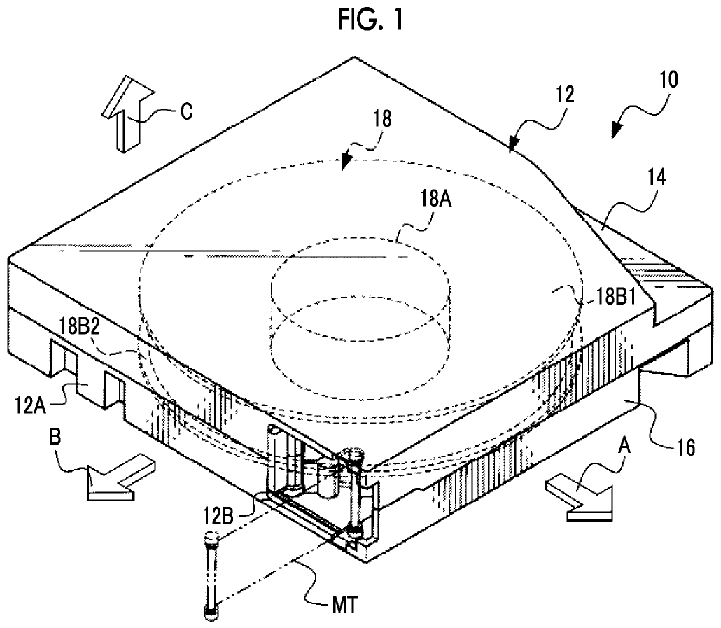

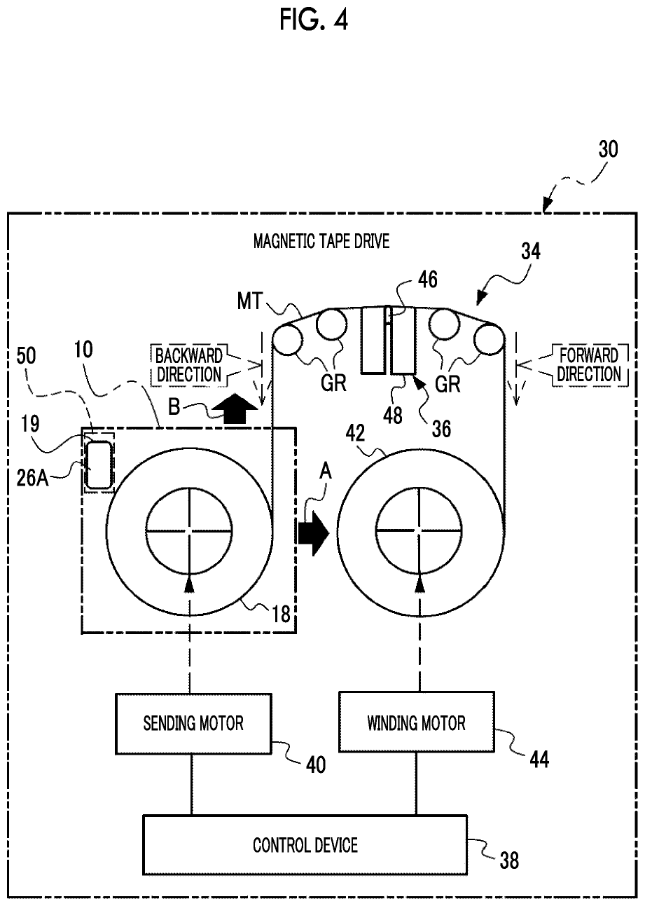

In the following description, for convenience of description, in FIG. 1, a loading direction of a magnetic tape cartridge 10 on a magnetic tape drive 30 (see FIG. 4) is indicated by an arrow A, a direction of the arrow A is referred to a front direction of the magnetic tape cartridge 10, and a side in the front direction of the magnetic tape cartridge 10 is referred to as a front side of the magnetic tape cartridge 10. In the following description on the structure, “front” indicates the front side of the magnetic tape cartridge 10.

In the following description, for convenience of description, in FIG. 1, a direction of an arrow B perpendicular to the direction of the arrow A is referred to as a right direction, and a side in the right direction of the magnetic tape cartridge 10 is referred to as a right side of the magnetic tape cartridge 10. In the following description on the structure, “right” indicates the right side of the magnetic tape cartridge 10.

In the following description, for convenience of description, in FIG. 1, a direction perpendicular to the direction of the arrow A and the direction of the arrow B is indicated by an arrow C, a direction of the arrow C is referred to as an upper direction of the magnetic tape cartridge 10, and a side in the upper direction of the magnetic tape cartridge 10 is referred to as an upper side of the magnetic tape cartridge 10. In the following description on the structure, “upper” indicates the upper side of the magnetic tape cartridge 10.

In the following description, for convenience of description, in FIG. 1, a direction opposite to the front direction of the magnetic tape cartridge 10 is referred to as a rear direction of the magnetic tape cartridge 10, and a side in the rear direction of the magnetic tape cartridge 10 is referred to as a rear side of the magnetic tape cartridge 10. In the following description on the structure, “rear” indicates the rear side of the magnetic tape cartridge 10.

In the following description, for convenience of description, in FIG. 1, a direction opposite to the upper direction of the magnetic tape cartridge 10 is referred to as a lower direction of the magnetic tape cartridge 10, and a side in the lower direction of the magnetic tape cartridge 10 is referred to as a lower side of the magnetic tape cartridge 10. In the following description on the structure, “lower” indicates the lower side of the magnetic tape cartridge 10.

In the following description, LTO will be described as an example of the standard of the magnetic tape cartridge 10. In the following description, although description will be provided on an assumption that the specification shown in Table 1 described below is applied to LTO according to the technique of the present disclosure, this is merely an example, and LTO according to the technique of the present disclosure may conform to the specification of IBM3592 magnetic tape cartridge.

TABLE 1

| Communication Command | ISO14443 | |
|---|---|---|
| Classification | Standard | LTO Specification |
| REQA to SELECT Series | 86 or 91 μs | 86 or 91 μs |
| | | (“1172/13.56 (MHz)” |
| | | or “1236/13.56 (MHz)”) |
| READ Series | Unspecified | 86 or 91 μs |
| | | (“1172/13.56 (MHz)” |
| | | or “1236/13.56 (MHz)”) |
| WRITE Series | Unspecified | about 10.02 ms |
| | | (“135828/13.56 (MHz)” |
| | | or “135892/13.56 (MHz)”) |

In Table 1, “REQA to SELECT Series” means a polling command described below. In “REQA to SELECT Series”, at least a “Request A” command, a “Request SN” command, and a “Select” command are included. “Request A” is a command that inquires a cartridge memory about what type of cartridge memory is. In the embodiment, “Request A” is one kind; however, the technique of the present disclosure is not limited thereto, and “Request A” may be a plurality of kinds. “Request SN” is a command that inquires the cartridge memory about a serial number. “Select” is a command that notifies the cartridge memory beforehand of preparation of reading and writing. READ Series is a command corresponding to a read-out command described below. WRITE Series is a command corresponding to a write-in command described below.

As shown in FIG. 1 as an example, the magnetic tape cartridge 10 has a substantially rectangular shape in plan view, and comprises a box-shaped case 12. The case 12 is formed of resin, such as polycarbonate, and comprises an upper case 14 and a lower case 16. The upper case 14 and the lower case 16 are bonded by welding (for example, ultrasonic welding) and screwing in a state in which a lower peripheral edge surface of the upper case 14 and an upper peripheral edge surface of the lower case 16 are brought into contact with each other. A bonding method is not limited to welding and screwing, and other bonding methods may be used.

Inside the case 12, a cartridge reel 18 is rotatably housed. The cartridge reel 18 comprises a reel hub 18A, an upper flange 18B1, and a lower flange 18B2. The reel hub 18A is formed in a cylindrical shape. The reel hub 18A is a shaft center portion of the cartridge reel 18, has a shaft center direction along an up-down direction of the case 12, and is disposed in a center portion of the case 12. Each of the upper flange 18B1 and the lower flange 18B2 is formed in an annular shape. A center portion in plan view of the upper flange 18B1 is fixed to an upper end portion of the reel hub 18A, and a center portion in plan view of the lower flange 18B2 is fixed to a lower end portion of the reel hub 18A. A magnetic tape MT is wound around an outer peripheral surface of the reel hub 18A, and an end portion in a width direction of the magnetic tape MT is held by the upper flange 18B1 and the lower flange 18B2. The reel hub 18A and the lower flange 18B2 may be molded integrally.

An opening 12B is formed on a front side of a right wall 12A of the case 12. The magnetic tape MT is pulled out from the opening 12B.

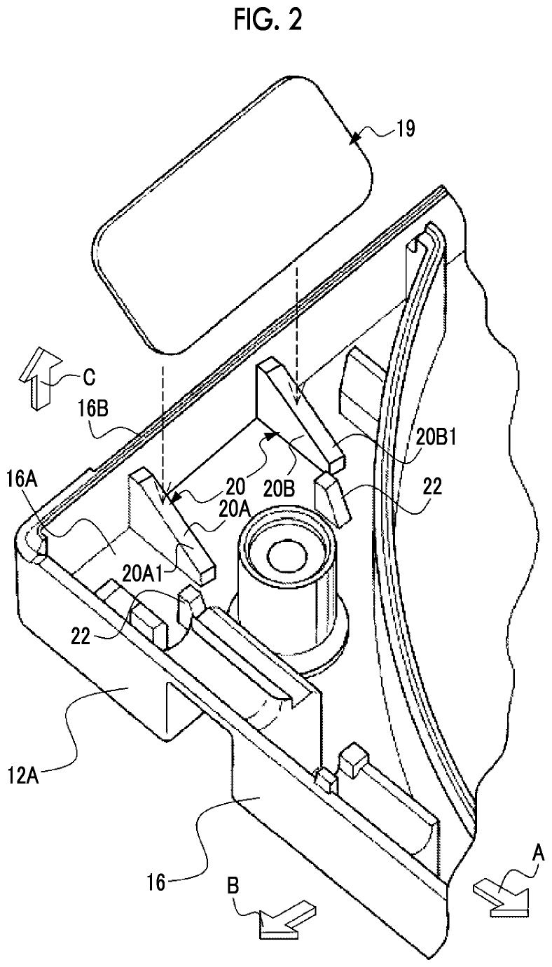

As shown in FIG. 2 as an example, a cartridge memory 19 is housed in a rear right end portion of the lower case 16. The cartridge memory 19 is an example of a “noncontact communication medium” according to the technique of the present disclosure. In the embodiment, a so-called passive type RFID tag is employed as the cartridge memory 19. Management information is stored in the cartridge memory 19. The management information is information for managing the magnetic tape cartridge 10. Examples of the management information include identification information capable of specifying the magnetic tape cartridge 10, a recording capacity of the magnetic tape MT, the outline of information (hereinafter, referred to as “recorded information”) recorded on the magnetic tape MT, items of the recorded information, and information indicating a recording format of the recorded information.

The cartridge memory 19 performs communication with an external device (not shown) in a noncontact manner. Examples of the external device include a reading and writing device that is used in a production process of the magnetic tape cartridge 10 and a reading and writing device (for example, a noncontact reading and writing device 50 shown in FIGS. 4 to 6) that is used in a magnetic tape drive (for example, the magnetic tape drive 30 shown in FIG. 4).

The external device performs reading and writing of various kinds of information to the cartridge memory 19 in a noncontact manner. Although details will be described below, the cartridge memory 19 generates power with electromagnetic application to a magnetic field from the external device. Then, the cartridge memory 19 operates using the generated power and performs transfer of various kinds of information with the external device by performing communication with the external device through the magnetic field. A communication system may be, for example, a system conforming to a known standard, such as ISO14443 or ISO18092, or may be a system conforming to the LTO Specification of ECMA319.

As shown in FIG. 2 as an example, a support member 20 is provided on an inner surface of a bottom plate 16A in the rear right end portion of the lower case 16. The support member 20 is a pair of inclined mounts that supports the cartridge memory 19 from below in an inclined state. A pair of inclined mounts is a first inclined mount 20A and a second inclined mount 20B. The first inclined mount 20A and the second inclined mount 20B are disposed at an interval in a right-left direction of the case 12 and are integrated with an inner surface of a rear wall 16B of the lower case 16 and the inner surface of the bottom plate 16A. The first inclined mount 20A has an inclined surface 20A1, and the inclined surface 20A1 is inclined downward from the inner surface of the rear wall 16B toward the inner surface of the bottom plate 16A. An inclined surface 20B1 is also inclined downward from the inner surface of the rear wall 16B toward the inner surface of the bottom plate 16A.

In front of the support member 20, a pair of position restriction ribs 22 is disposed at an interval in the right-left direction. A pair of position restriction ribs 22 is provided upright on the inner surface of the bottom plate 16A and restricts a position of a lower end portion of the cartridge memory 19 in a state of being disposed on the support member 20.

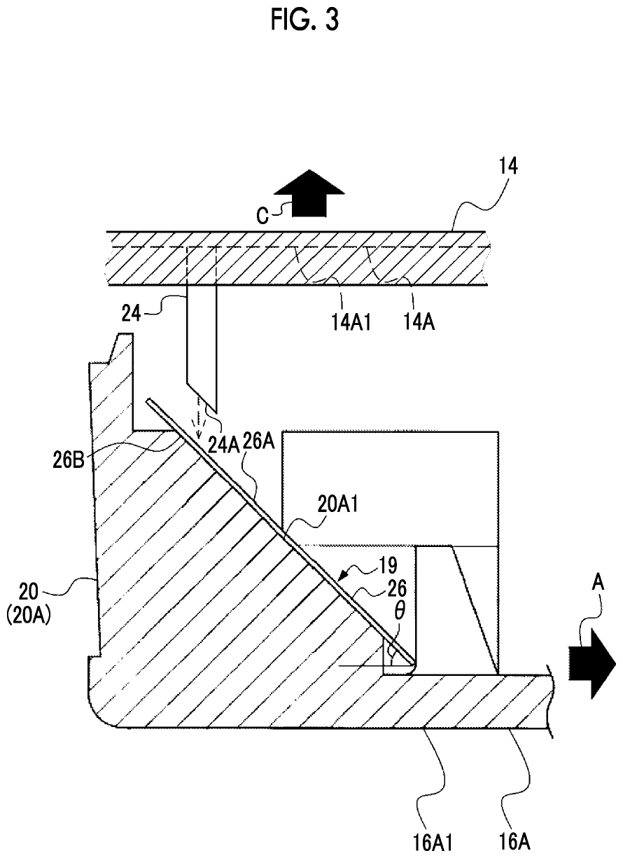

As shown in FIG. 3 as an example, a reference surface 16A1 is formed on an outer surface of the bottom plate 16A. The reference surface 16A1 is a plane. Here, the plane indicates a surface parallel to a horizontal plane in a case where the lower case 16 is placed on the horizontal plane such that the bottom plate 16A turns toward a lower side. An inclination angle θ of the support member 20, that is, an inclination angle of each of the inclined surface 20A1 and the inclined surface 20B1 is 45 degrees with respect to the reference surface 16A1. The inclination angle of 45 degrees is merely an example, and may be in a range of “0 degrees<inclination angle θ<45 degrees” or may be equal to or greater than 45 degrees.

The cartridge memory 19 comprises a substrate 26. The substrate 26 is an example of a “substrate” according to the technique of the present disclosure. The substrate 26 has a substantially rectangular flat plate shape, and has two surfaces, that is, a front surface 26A and a back surface 26B in a thickness direction. The substrate 26 is placed on the support member 20 such that the back surface 26B of the substrate 26 turns toward a lower side, and the support member 20 supports the back surface 26B of the substrate 26 from below. A part of the back surface 26B of the substrate 26 is in contact with the inclined surface of the support member 20, that is, the inclined surfaces 20A1 and 20B1, and the front surface 26A of the substrate 26 is exposed to an inner surface 14A1 side of a top plate 14A.

The upper case 14 comprises a plurality of ribs 24. A plurality of ribs 24 are disposed at intervals in the right-left direction of the case 12. A plurality of ribs 24 are provided to protrude downward from the inner surface 14A1 of the top plate 14A of the upper case 14, and a distal end surface 24A of each rib 24 has an inclined surface corresponding to the inclined surfaces 20A1 and 20B1. That is, the distal end surface 24A of each rib 24 is inclined at 45 degrees with respect to the reference surface 16A1.

In a case where the upper case 14 is bonded to the lower case 16 as described above in a state in which the cartridge memory 19 is disposed on the support member 20, the distal end surface 24A of each rib 24 comes into contact with the substrate 26 from the front surface 26A side, and the substrate 26 is pinched by the distal end surface 24A of each rib 24 and the inclined surface of the support member 20. With this, a position in an up-down direction of the cartridge memory 19 is restricted by the ribs 24.

As shown in FIG. 4 as an example, the magnetic tape drive 30 comprises a transport device 34, a reading head 36, and a control device 38. The magnetic tape cartridge 10 is loaded into the magnetic tape drive 30. The magnetic tape drive 30 is a device that pulls out the magnetic tape MT from the magnetic tape cartridge 10 and reads recorded information from the pulled-out magnetic tape MT using the reading head 36 by a linear serpentine method. In the embodiment, in order words, reading of the recorded information indicates reproduction of the recorded information.

The control device 38 controls the entire magnetic tape drive 30. In the embodiment, although the control device 38 is realized by an ASIC, the technique of the present disclosure is not limited thereto. For example, the control device 38 may be realized by an FPGA. Alternatively, the control device 38 may be realized by a computer including a CPU, a ROM, and a RAM. In addition, the control device 38 may be realized by combining two or more of an AISC, an FPGA, and a computer. That is, the control device 38 may be realized by a combination of a hardware configuration and a software configuration.

The transport device 34 is a device that selectively transports the magnetic tape MT in a forward direction and a backward direction, and comprises a sending motor 40, a winding reel 42, a winding motor 44, a plurality of guide rollers GR, and the control device 38.

The sending motor 40 rotationally drives the cartridge reel 18 in the magnetic tape cartridge 10 under the control of the control device 38. The control device 38 controls the sending motor 40 to control a rotation direction, a rotation speed, rotation torque, and the like of the cartridge reel 18.

The winding motor 44 rotationally drives the winding reel 42 under the control of the control device 38. The control device 38 controls the winding motor 44 to control a rotation direction, a rotation speed, rotation torque, and the like of the winding reel 42.

In a case where the magnetic tape MT is wound around the winding reel 42, the sending motor 40 and the winding motor 44 are rotated by the control device 38 such that the magnetic tape MT runs in the forward direction. Rotation speeds, rotation torque, and the like of the sending motor 40 and the winding motor 44 are adjusted depending on a speed of the magnetic tape MT wound around the winding reel 42.

In a case where the magnetic tape MT is rewound to the cartridge reel 18, the sending motor 40 and the winding motor 44 are rotated by the control device 38 such that the magnetic tape MT runs in the backward direction. Rotation speeds, rotation torque, and the like of the sending motor 40 and the winding motor 44 are adjusted depending on a speed of the magnetic tape MT wound around the winding reel 42.

The rotation speed, the rotation torque, and the like of each of the sending motor 40 and the winding motor 44 are adjusted in this manner, whereby tension in a predetermined range is applied to the magnetic tape MT. Here, the predetermined range indicates, for example, a range of tension obtained from a computer simulation and/or a test with a real machine as a range of tension in which data can be read from the magnetic tape MT by the reading head 36.

In the embodiment, although the rotation speed, the rotation torque, and the like of each of the sending motor 40 and the winding motor 44 are controlled such that the tension of the magnetic tape MT is controlled, the technique of the present disclosure is not limited thereto. For example, the tension of the magnetic tape MT may be controlled using a dancer roller or may be controlled by drawing the magnetic tape MT to a vacuum chamber.

Each of a plurality of guide rollers GR is a roller that guides the magnetic tape MT. A running path of the magnetic tape MT is determined by separately disposing a plurality of guide rollers GR at positions straddling over the reading head 36 between the magnetic tape cartridge 10 and the winding reel 42.

The reading head 36 comprises a reading element 46 and a holder 48. The reading element 46 is held by the holder 48 to come into contact with the magnetic tape MT during running, and reads recorded information from the magnetic tape MT transported by the transport device 34.

The magnetic tape drive 30 comprises the noncontact reading and writing device 50. The noncontact reading and writing device 50 is an example of an “outside” according to the technique of the present disclosure. The noncontact reading and writing device 50 is disposed to confront the back surface 26B of the cartridge memory 19 below the magnetic tape cartridge 10 in a state in which the magnetic tape cartridge 10 is loaded. The state in which the magnetic tape cartridge 10 is loaded into the magnetic tape drive 30 indicates, for example, a state in which the magnetic tape cartridge 10 reaches a position determined in advance as a position where reading of recorded information from the magnetic tape MT by the reading head 36 starts.

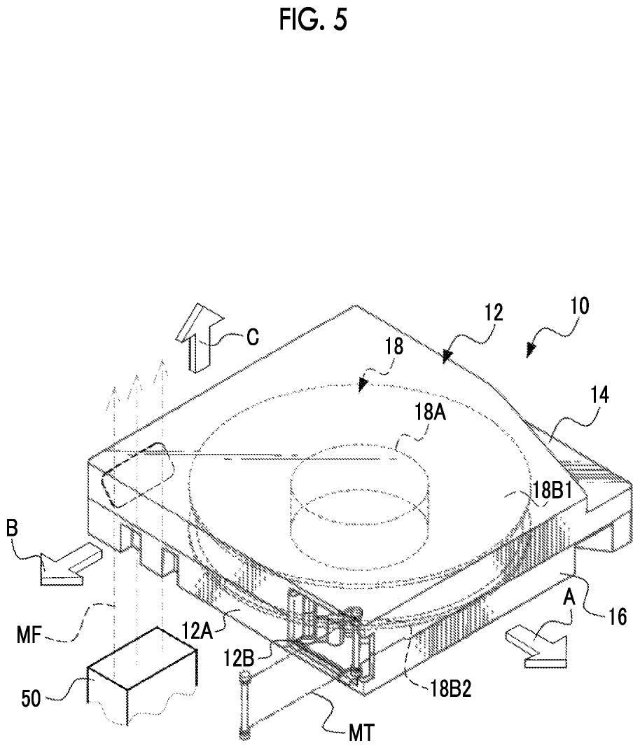

As shown in FIG. 5 as an example, the noncontact reading and writing device 50 emits a magnetic field MF from below the magnetic tape cartridge 10 toward the cartridge memory 19. The magnetic field MF passes through the cartridge memory 19. The magnetic field MF is an example of a “magnetic field” according to the technique of the present disclosure.

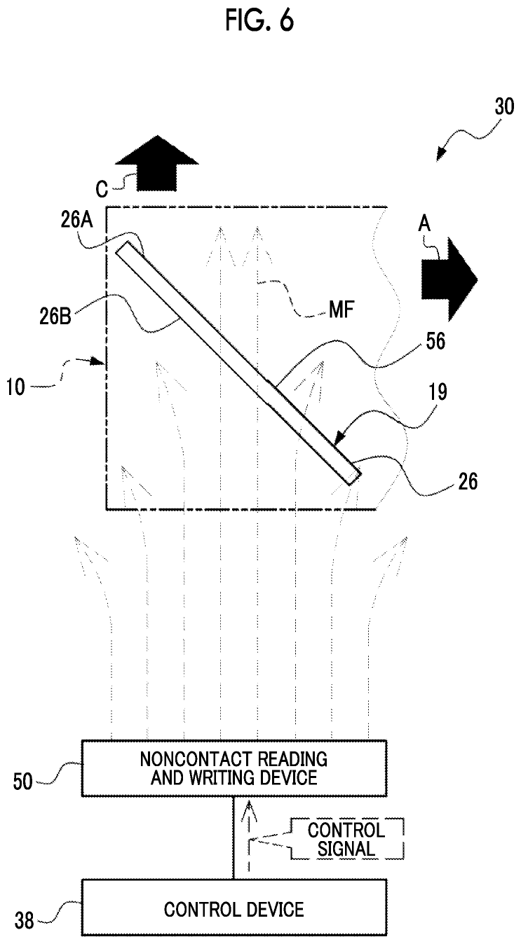

As shown in FIG. 6 as an example, the noncontact reading and writing device 50 is connected to the control device 38. The control device 38 outputs a control signal for controlling the cartridge memory 19 to the noncontact reading and writing device 50. The noncontact reading and writing device 50 emits the magnetic field MF toward the cartridge memory 19 in compliance with the control signal input from the control device 38. The magnetic field MF passes through the cartridge memory 19 from the back surface 26B side to the front surface 26A side.

The noncontact reading and writing device 50 spatially transmits a command signal to the cartridge memory 19 under the control of the control device 38. Though described below in detail, the command signal is a signal indicating a command to the cartridge memory 19. In a case where the command signal is spatially transmitted from the noncontact reading and writing device 50 to the cartridge memory 19, the command signal is included in the magnetic field MF in compliance with an instruction from the control device 38 by the noncontact reading and writing device 50. In other words, the command signal is superimposed on the magnetic field MF. That is, the noncontact reading and writing device 50 transmits the command signal to the cartridge memory 19 through the magnetic field MF under the control of the control device 38.

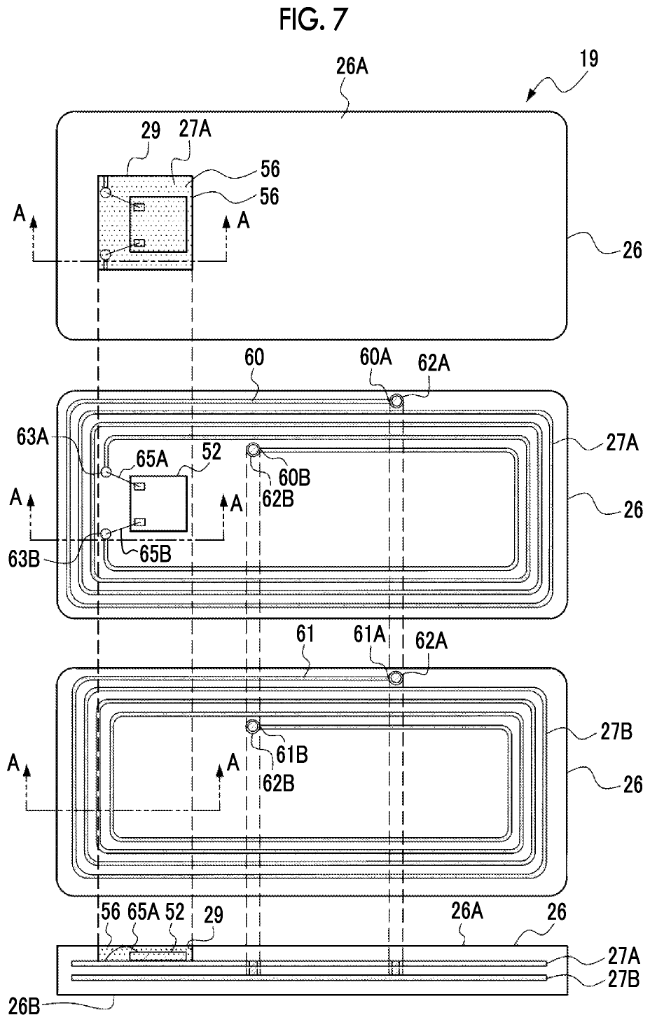

As shown in FIG. 7 as an example, the substrate 26 of the cartridge memory 19 has a first layer 27A and a second layer 27B. The first layer 27A and the second layer 27B are buried at overlapping positions in the thickness direction of the substrate 26 in an order of the first layer 27A and the second layer 27B from the front surface 26A side to the back surface 26B side of the substrate 26. A first coil 60 wound in a loop shape along an outer periphery of the substrate 26 is formed in the first layer 27A. A second coil 61 wound in a loop shape along the outer periphery of the substrate 26 is formed in the second layer 27B. Here, although copper foil is employed as a material of the first coil 60 and the second coil 61, the copper foil is merely an example, and for example, other kinds of conductive materials, such as aluminum foil, may be employed. The first layer 27A and the second layer 27B are an example of “a plurality of layers” according to the technique of the present disclosure. The first layer 27A is an example of a “first layer” according to the technique of the present disclosure, and the second layer 27B is an example of a “second layer” according to the technique of the present disclosure. The first coil 60 is an example of an “antenna coil” according to the technique of the present disclosure, and the second coil 61 is an example of an “auxiliary antenna coil” according to the technique of the present disclosure.

An outer peripheral end 60A of the first coil 60 wound in a loop shape is connected to a first through-hole 62A buried in the substrate 26, and an inner peripheral end 60B of the first coil 60 is connected to a second through-hole 62B buried in the substrate 26. An outer peripheral end 61A of the second coil 61 wound in a loop shape is connected to the first through-hole 62A buried in the substrate 26, and an inner peripheral end 61B of the first coil 61 is connected to the second through-hole 62B buried in the substrate 26. The outer peripheral end 60A and the inner peripheral end 60B of the first coil 60 is an example of “one end and the other end of the antenna coil” according to the technique of the present disclosure. The first through-hole 62A and the second through-hole 62B are an example of a “through-hole” according to the technique of the present disclosure.

The first through-hole 62A and the second through-hole 62B have through-holes passing through the first layer 27A and the second layer 27B buried in the substrate 26, respectively. Copper plating is performed on an inner peripheral surface of the through-hole, and the inside of the through-hole is filled with a conductive material. Copper plating is merely an example, and for example, plating of other kinds of conductive materials, such as aluminum plating, may be employed. The first through-hole 62A electrically connects the outer peripheral end 60A of the first coil 60 and the outer peripheral end 61A of the second coil 61. The second through-hole 62B electrically connects the inner peripheral end 60B of the first coil 60 and the inner peripheral end 61B of the second coil 61.

That is, the outer peripheral end 60A and the inner peripheral end 60B of the first coil 60 are electrically connected through the first through-hole 62A and the second through-hole 62B, and the second coil 61 formed in the second layer 27B. In this way, the first coil 60 and the second coil 61 connected in series through the first through-hole 62A and the second through-hole 62B induces an induced current with application of the magnetic field MF (see FIGS. 5 and 6) from the noncontact reading and writing device 50.

The IC chip 52 is mounted on the first layer 27A. The IC chip 52 is adhered to the front surface of the first layer 27A. A first conduction portion 63A and a second conduction portion 63B are provided in the middle of the first coil 60. The IC chip 52 is electrically connected to the first conduction portion 63A and the second conduction portion 63B by a wire connection method. Specifically, the first conduction portion 63A and the second conduction portion 63B have solder, and one terminal of a positive electrode terminal and a negative electrode terminal of the IC chip 52 is soldered to the first conduction portion 63A through wiring 65A, and the other terminal is soldered to the second conduction portion 63B through wiring 65B. The IC chip 52 is disposed on the inner peripheral side of the first coil 60 in the winding direction. The IC chip 52 is an example of an “IC chip” according to the technique of the present disclosure.

An opening 29 is formed at a position of the front surface 26A of the substrate 26 corresponding to a position of the IC chip 52 mounted on the first layer 27A. The opening 29 has a size determined in association with a management standard of a glob top that is applied to the cartridge memory 19. The opening 29 is an example of an “opening” according to the technique of the present disclosure.

The opening 29 is sealed with a sealing material 57. That is, the opening 29 is filled with the sealing material 57, whereby a glob top 56 with which the IC chip 52, the first conduction portion 63A and the second conduction portion 63B, and the wiring 65A and 65B are sealed is formed to have a size associated with the management standard. Here, as the sealing material 57, ultraviolet curable resin that is cured by ultraviolet rays is employed. The ultraviolet curable resin is merely an example, and photocurable resin that is cured by light in a wavelength range other than ultraviolet rays may be used as the sealing material 57, thermosetting resin may be used as the sealing material 57, or an adhesive may be used as the sealing material 57. The sealing material 57 is an example of a “sealing material” according to the technique of the present disclosure.

According to the technique known in the art, in a case where a glob top is formed on a plane, first, a frame-shaped dam portion is formed by dropping the sealing material 57 along an outer shape of the glob top. After the dam portion is cured, a rectangular glob top is formed by filling the inside of the dam portion with the sealing material 57. According to this method, the dimension accuracy of the glob top is expected to be hardly increased. In contrast, according to the embodiment, the opening 29 is formed to have a size associated with the management standard of the glob top 56, whereby the glob top 56 with satisfactory dimension accuracy is easily created compared to a method in which the opening 29 is not used.

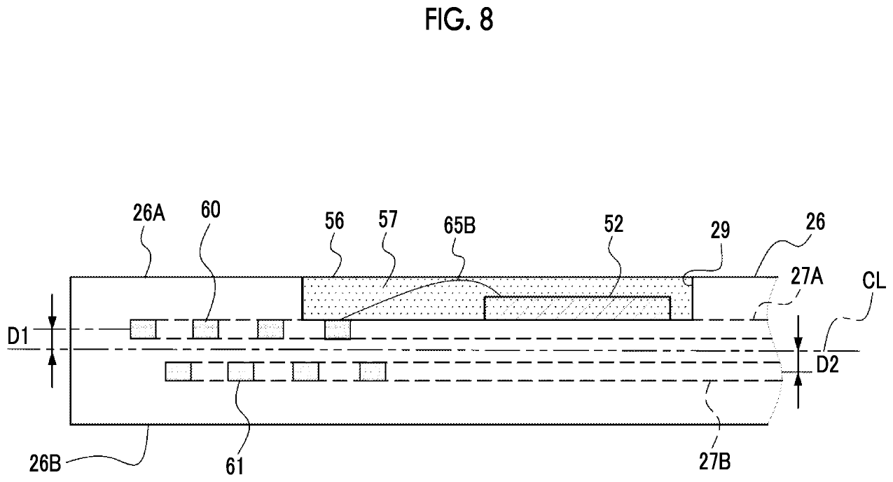

FIG. 8 is an example of a schematic sectional view of the cartridge memory 19 taken along the line A-A. As shown in FIG. 8 as an example, the first coil 60 formed in the first layer 27A and the second coil 61 formed in the second layer 27B are disposed in a zigzag pattern in the thickness direction of the substrate 26. In a case where the first coil 60 and the second coil 61 are disposed at overlapping positions in the thickness direction of the substrate 26, inductance components of the first coil 60 and the second coil 61 are coupled, and the first coil 60 and the second coil 61 are regarded as one thick conductive wire in characteristics. In contrast, according to the embodiment, since the first coil 60 and the second coil 61 are disposed in a zigzag pattern, inductance components are hardly coupled compared to a case where the first coil 60 and the second coil 61 are disposed at overlapping positions in the thickness direction of the substrate 26.

The first layer 27A and the second layer 27B are disposed at positions equally separated from the center CL of the substrate 26 in the thickness direction. Specifically, in a case where a distance between a central line CL indicating the center of the substrate 26 in the thickness direction and the center of the first layer 27A in the thickness direction is referred to as a first distance D1, and a distance between the central line CL and the center of the second layer 27B in the thickness direction is referred to as a second distance D2, the first distance D1 and the second distance D2 are equal. The first distance D1 is an example of a “first distance” according to the technique of the present disclosure, and the second distance D2 is an example of a “second distance” according to the technique of the present disclosure.

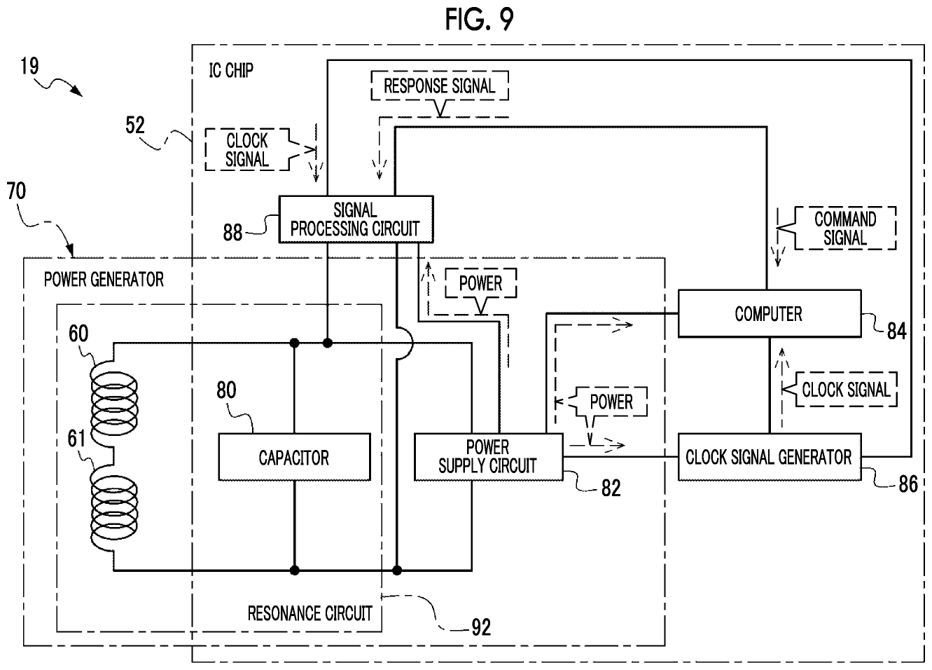

As shown in FIG. 9 as an example, the IC chip 52 comprises a capacitor 80, a power supply circuit 82, a computer 84, a clock signal generator 86, and a signal processing circuit 88. The IC chip 52 functions as a control device for the cartridge memory 19 in a case where a control program is installed thereon. The computer 84, the clock signal generator 86, and the signal processing circuit 88 are an example of a “processing circuit” according to the technique of the present disclosure.

The cartridge memory 19 comprises a power generator 70. The power generator 70 generates power with application of the magnetic field MF from the noncontact reading and writing device 50 to the first coil 60 formed in the first layer 27A and the second coil 61 formed in the second layer 27B. Specifically, the power generator 70 generates alternating-current power using a resonance circuit 92, converts the generated alternating-current power into direct-current power, and outputs the direct-current power. The power generator 70 has the resonance circuit 92 and the power supply circuit 82. The resonance circuit 92 comprises the first coil 60, the second coil 61, and the capacitor 80. The capacitor 80 is a capacitor incorporated in the IC chip 52, and the power supply circuit 82 is also a circuit incorporated in the IC chip 52. The first coil 60 and the second coil 61 are connected in series through the first through-hole 62A and the second through-hole 62B (see FIG. 7). The capacitor 80 is connected in parallel with the first coil 60 and the second coil 61.

The resonance circuit 92 generates alternating-current power by generating a resonance phenomenon at a predetermined resonance frequency using an induced current induced by the first coil 60 and the second coil 61 with the magnetic field MF passing through the first coil 60 and the second coil 61 and outputs the generated alternating-current power to the power supply circuit 82. In the cartridge memory 19, the resonance circuit 92 is made to resonate at the predetermined resonance frequency with application of the magnetic field MF. The predetermined resonance frequency is, for example, 13.56 MHz. The resonance frequency is not limited to 13.56 MHz, and may be appropriately decided depending on the specification or the like of the cartridge memory 19 and/or the noncontact reading and writing device 50.

The power supply circuit 82 has a rectification circuit, a smoothing circuit, and the like. The rectification circuit is a full-wave rectification circuit having a plurality of diodes. The full-wave rectification circuit is merely an example, and a half-wave rectification circuit may be used. The smoothing circuit includes a capacitor and a resistor. The power supply circuit 82 converts the alternating-current power input from the resonance circuit 92 into direct-current power and supplies the converted direct-current power (hereinafter, simply referred to as “power”) to various drive elements in the IC chip 52. Examples of various drive elements include the computer 84, the clock signal generator 86, and the signal processing circuit 88. In this way, power is supplied to various drive elements in the IC chip 52 by the power generator 70, whereby various drive elements in the IC chip 52 operate using power generated by the power generator 70.

The computer 84 comprises a CPU, an NVM, and a RAM (all are not shown). The control program and the management information are stored in the NVM. The CPU controls the operation of the cartridge memory 19 by reading the control program from the NVM and executing the control program on the RAM.

The CPU selectively executes polling processing, read-out processing, and write-in processing according to the command signal input from the signal processing circuit 88. The polling processing is processing of establishing communication between the cartridge memory 19 and the noncontact reading and writing device 50, and is executed, for example, as preparation processing in a pre-stage of the read-out processing and the write-in processing. The read-out processing is processing of reading out the management information and the like from the NVM. The write-in processing is processing of writing the management information and the like in the NVM. All of the polling processing, the read-out processing, and the write-in processing (hereinafter, referred to as various kinds of processing in a case where there is no need for distinction) are executed by the CPU in compliance with the clock signals generated by the clock signal generator 86. That is, the CPU executes various kinds of processing at a processing speed according to the clock frequency.

The clock signal generator 86 generates a clock signal and outputs the clock signal to the computer 84. The computer 84 operates in association with the clock signal input from the clock signal generator 86.

The signal processing circuit 88 is connected to the resonance circuit 92. The signal processing circuit 88 has a decoding circuit and an encoding circuit (both are not shown). The decoding circuit of the signal processing circuit 88 extracts the command signal from the magnetic field MF received by the first coil 60 and the second coil 61, decodes the command signal, and outputs the command signal to the computer 84. The computer 84 outputs a response signal to the command signal to the signal processing circuit 88. That is, the computer 84 executes processing according to the command signal input from the signal processing circuit 88 and outputs a processing result as a response signal to the signal processing circuit 88. In the signal processing circuit 88, in a case where the response signal is input from the computer 84, the encoding circuit of the signal processing circuit 88 encodes the response signal to modulate the response signal and outputs the response signal to the resonance circuit 92. The resonance circuit 92 transmits the response signal input from the encoding circuit of the signal processing circuit 88 to the noncontact reading and writing device 50 through the magnetic field MF. That is, in a case where the response signal is transmitted from the cartridge memory 19 to the noncontact reading and writing device 50, the response signal is included in the magnetic field MF. In other words, the response signal is superimposed on the magnetic field MF.

As described above, the cartridge memory 19 comprises the first coil 60 that is formed in the substrate 26 and induces power with application of the magnetic field MF from the noncontact reading and writing device 50, and the computer 84, the clock signal generator 86, and the signal processing circuit 88 that operate the power induced by the first coil 60. The substrate 26 has the first layer 27A and the second layer 27B laminated in the thickness direction. The first coil 60 is wound in a loop shape in the first layer 27A. The second coil 61 is wound in a loop shape in the second layer 27B. The outer peripheral end 60A and the inner peripheral end 60B of the first coil 60 are electrically connected through the second coil 61 in the second layer 27B different from the first layer 27A. Both the first layer 27A and the second layer 27B are buried in the substrate 26. Therefore, according to this configuration, it is possible to prevent damage to the front surfaces of the first coil 60 and the second coil 61.

The outer peripheral end 60A and the inner peripheral end 60B of the first coil 60 are electrically connected in the second layer 27B through the first through-hole 62A and the second through-hole 62B. Therefore, according to this configuration, it is possible to connect the outer peripheral end 60A and the inner peripheral end 60B of the first coil 60 in a space-saving manner compared to a case where the outer peripheral end 60A and the inner peripheral end 60B of the first coil 60 are connected by a wire.

The first distance D1 indicating the distance between the central line CL indicating the center of the substrate 26 in the thickness direction and the center of the first layer 27A in the thickness direction and the second distance D2 indicating the distance between the central line CL and the center of the second layer 27B in the thickness direction are equal. Therefore, according to this configuration, it is possible to make power to be generated equal in a case where the magnetic field MF is received on the front surface 26A of the substrate 26 and in a case where the magnetic field MF is received on the back surface 26B. The term “equal” used herein also includes a meaning of equal in a meaning including an error that is generally allowed in the technical field to which the technique of the present disclosure belongs, an error to such an extent not contrary to the spirit and scope of the technique of that the present disclosure, in addition to a meaning of completely equal.

The first coil 60 formed in the first layer 27A and the second coil 61 formed in the second layer 27B are disposed in a zigzag pattern in the thickness direction of the substrate 26. Therefore, according to this configuration, it is possible to obtain more power compared to a case where the first coil 60 and the second coil 61 are disposed at overlapping positions in the thickness direction.

The computer 84, the clock signal generator 86, and the signal processing circuit 88 are formed in the IC chip 52. The IC chip 52 is mounted on the first layer 27A and is inserted in the middle of the first coil 60 formed in the first layer 27A. Therefore, according to this configuration, it is possible to shorten a wiring distance between the IC chip 52 and the first coil 60 compared to a case where IC chip 52 is mounted on a layer other than the first layer 27A.

The first layer 27A is buried in the substrate 26. Therefore, according to this configuration, it is possible to suppress roughness compared to a case where the first layer 27A of the cartridge memory 19 protrudes from the substrate 26 due to the mounting of the IC chip 52.

The front surface 26A of the substrate 26 has the opening 29 at the position corresponding to the position of the IC chip 52 mounted on the first layer 27A, and the opening 29 is sealed with the sealing material 57. Therefore, according to this configuration, it is possible to protect the IC chip 52, and the wiring 65A and 65B between the IC chip 52 and the first conduction portion 63A and the second conduction portion 63B by the sealing material 57.

The size of the opening 29 is determined in association with the management standard of the glob top 56 that is applied to the cartridge memory 19. Therefore, according to this configuration, it is possible to create the glob top 56 having a size conforming to the management standard of the glob top 56 that is applied to the cartridge memory 19.

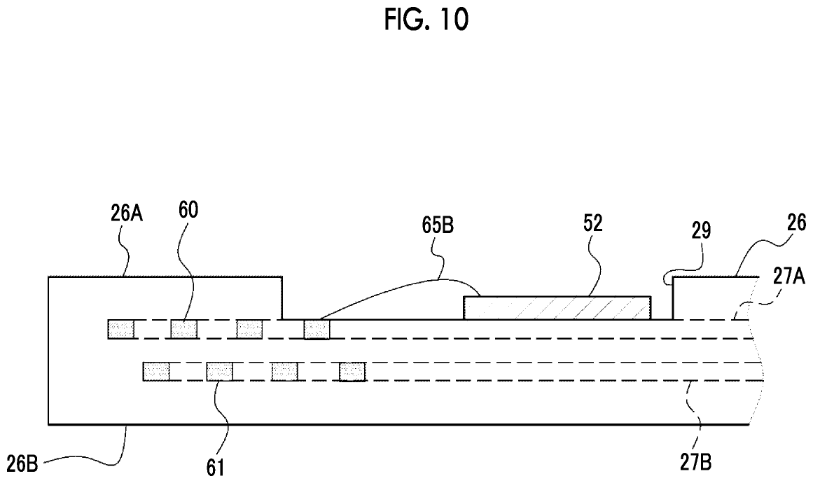

In the above-described embodiment, although a form example where the opening 29 formed in the front surface 26A of the substrate 26 is sealed with the sealing material 57 has been described, the technique of the present disclosure is not limited thereto. As shown in FIG. 10 as an example, the opening 29 may be an exposure opening for exposing the IC chip 52 mounted on the first layer 27A. In this case, the opening 29 is an example of an “exposure opening” according to the technique of the present disclosure. Therefore, according to this configuration, it is possible to perform treatment on the IC chip 52 buried in the substrate 26.

In the above-described embodiment, although a form example where the first layer 27A and the second layer 27B are buried in the substrate 26 in the order of the first layer 27A and the second layer 27B from the front surface 26A side to the back surface 26B side of the substrate 26 has been described, the technique of the present disclosure is not limited thereto. The first layer 27A and the second layer 27B may be buried in the substrate 26 in an order of the first layer 27A and the second layer 27B from the back surface 26B side to the front surface 26A side of the substrate 26. In this case, an opening is formed at a position of the back surface 26B of the substrate 26 corresponding to a position of the IC chip 52. The opening may be sealed with the sealing material 57 or may be an exposure opening for exposing the IC chip 52.

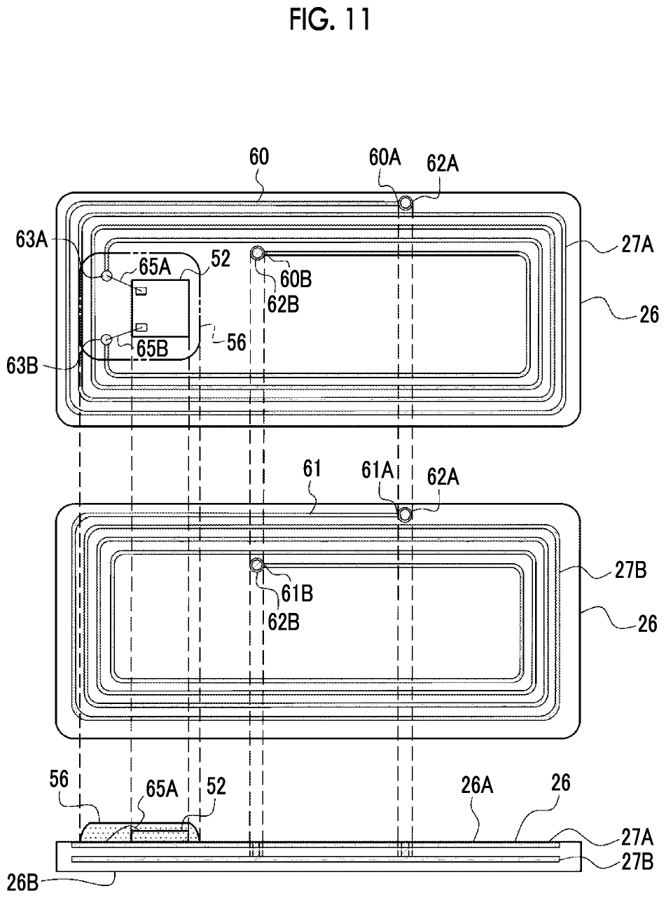

In the above-described embodiment, although a form example where both the first layer 27A and the second layer 27B are buried in the substrate 26 has been described, the technique of the present disclosure is not limited thereto. As shown in FIG. 11 as an example, the first layer 27A may be provided on the front surface 26A of the substrate 26, and the second layer 27B may be buried in the substrate 26. Alternatively, the first layer 27A may be buried in the substrate 26, and the second layer 27B may be provided on the front surface 26A or the back surface 26B of the substrate 26. In all cases, it should suffice that at least one of the first layer 27A or the second layer 27B is e buried in the substrate 26. Therefore, according to this configuration, it is possible to increase the durability of at least one of the first coil 60 or the second coil 61 compared to a case where both the first layer 27A and the second layer 27B are exposed on the front surface 26A and/or the back surface 26B of the substrate 26.

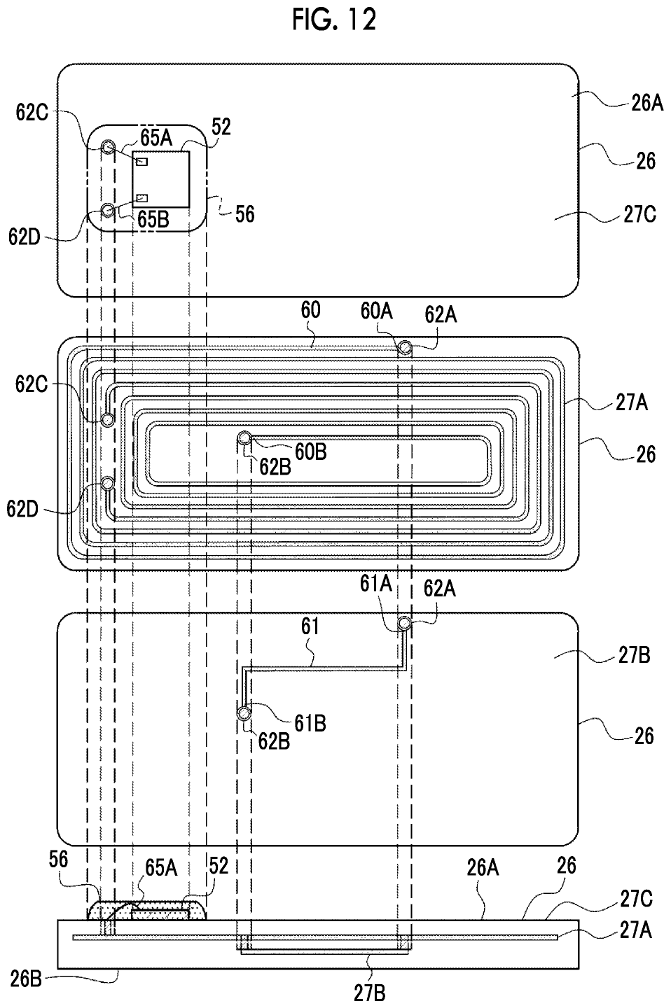

In the above-described embodiment, although a form example where the IC chip 52 is mounted on the first layer 27A has been described, the technique of the present disclosure is not limited thereto. As shown in FIG. 12 as an example, the IC chip 52 may be mounted on a third layer 27C different from the first layer 27A and the second layer 27B. The third layer 27C is a layer formed on the front surface 26A of the substrate 26. The IC chip 52 is mounted on the third layer 27C, that is, the front surface 26A of the substrate 26.

In an example shown in FIG. 12, a third through-hole 62C and a fourth through-hole 62D, instead of the first conduction portion 63A and the second conduction portion 63B, are provided in the middle of the first coil 60. The third through-hole 62C and the fourth through-hole 62D provided in the first layer 27A are in a conduction state to the third layer 27C, and the IC chip 52 are connected to the third through-hole 62C and the fourth through-hole 62D through the wiring 65A and 65B. With this, the IC chip 52 mounted on the third layer 27C is electrically connected in the middle of the first coil 60 formed in the first layer 27A.

In the configuration shown in FIG. 12, the first layer 27A is a dedicated layer of the first coil 60. Therefore, according to this configuration, it is possible to increase a winding number of the first coil 60 compared to a case where the IC chip 52 is mounted on the first layer 27A.

The crank-shaped second coil 61 is formed in the second layer 27B. The second coil 61 electrically connects the outer peripheral end 60A and the inner peripheral end 60B of the first coil 60 through the first through-hole 62A and the second through-hole 62B. In FIG. 12, although a form example where the second coil 61 is formed in a crank shape has been described, the technique of the present disclosure is not limited thereto, and the second coil 61 may be formed in a linear shape. The second coil 61 may be formed in a loop shape, like the first coil 60. In this case, it is possible to increase a winding number of the second coil 61 compared to a case where the second coil 61 has a crank shape or a loop shape.

In the configuration shown in FIG. 12, the third layer 27C is a layer formed on the front surface 26A of the substrate 26. Therefore, according to this configuration, it is possible to simplify the mounting work of the IC chip 52 compared to a case where the IC chip 52 is mounted on a layer buried in the substrate 26. In FIG. 12, although a form example where the third layer 27C is formed on the front surface 26A of the substrate 26 has been described, the technique of the present disclosure is not limited thereto, and the third layer 27C may be formed on the back surface 26B of the substrate 26.

In the above-described embodiment, although a form example where the IC chip 52 and the first coil 60 are connected by the wiring 65A and 65B (see FIG. 7), the technique of the present disclosure is not limited thereto. For example, the IC chip 52 and the first coil 60 may be connected by a flip-chip connection method.

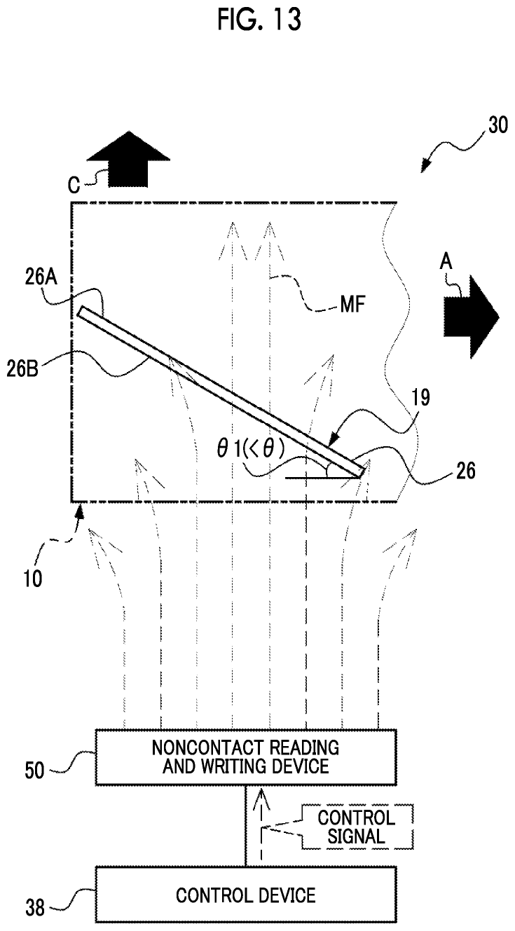

In the above-described embodiment, although 45 degrees have been exemplified as the inclination angle θ, the technique of the present disclosure is not limited thereto. As shown in FIG. 13 as an example, an inclination angle θ1 smaller than the inclination angle θ may be employed as the inclination angle with respect to the reference surface 16A1 of the cartridge memory 19. An example of the inclination angle θ1 is 30 degrees. Since the inclination angle θ1 is an angle smaller than the inclination angle θ, it is possible to make a large number of lines of magnetic force pass through the first coil 60 and the second coil 61 (see FIG. 7 together) compared to the case of the inclination angle θ. As a result, the first coil 60 and the second coil 61 can obtain a large induced current in a state in which the magnetic tape cartridge 10 is loaded into the magnetic tape drive 30, compared to the case of the inclination angle θ.

What is claimed is:

1. A noncontact communication medium comprising:
an antenna coil that is formed in a substrate and induces power with application of a magnetic field from an outside; and
a processing circuit that operates using the power induced by the antenna coil,
wherein the substrate has a plurality of layers in a thickness direction,
the antenna coil is wound in a loop shape in a first layer among the plurality of layers,
one end and the other end of the antenna coil are electrically connected through an auxiliary antenna coil wound in a loop shape in a second layer different from the first layer among the plurality of layers, and
at least one of the first layer or the second layer is buried in the substrate.

2. The noncontact communication medium according to claim 1,
wherein the one end and the other end are electrically connected in the second layer through a through-hole.

3. The noncontact communication medium according to claim 1,
wherein both the first layer and the second layer are buried in the substrate.

4. The noncontact communication medium according to claim 3,
wherein a first distance indicating a distance between a center of the substrate in the thickness direction and the first layer is equal to a second distance indicating a distance between the center of the substrate in the thickness direction and the second layer.

5. The noncontact communication medium according to claim 1,
wherein the antenna coil formed in the first layer and the auxiliary antenna coil formed in the second layer are disposed in a zigzag pattern in the thickness direction of the substrate.

6. The noncontact communication medium according to claim 1,
wherein the processing circuit is formed in an IC chip, and
the IC chip is mounted on the first layer and is inserted in the middle of the antenna coil formed in the first layer.

7. The noncontact communication medium according to claim 6,
wherein the first layer is buried in the substrate.

8. The noncontact communication medium according to claim 7,
wherein a front surface or a back surface of the substrate has an exposure opening for exposing the IC chip mounted on the first layer.

9. The noncontact communication medium according to claim 7,
wherein a front surface or a back surface of the substrate has an opening formed at a position corresponding to a position of the IC chip mounted on the first layer, and
the opening is sealed with a sealing material.

10. The noncontact communication medium according to claim 9,
wherein a size of the opening is determined in association with a management standard of a glob top that is applied to the noncontact communication medium.

11. The noncontact communication medium according to claim 1,
wherein the processing circuit is formed in an IC chip, and
the IC chip is mounted on a third layer different from the first layer and the second layer among the plurality of layers.

12. The noncontact communication medium according to claim 11,
wherein the third layer is a front surface or a back surface of the substrate.
